(19) United States
(12) Patent Application Publication
(10) Pub. No.: US 2018/0280861 A1
(43) Pub. Date: Oct. 4, 2018

(54) Mixer Truck Water Spray Bar

(71) Applicant: JMAC Resources, Inc., Williston, ND (US)

(72) Inventors: Arthur L. Thompson, Bismarck, ND (US); Jeffrey P. Lodi, Ephrata, WA (US); Joseph R. Paquette, JR., Bismarck, ND (US)

(73) Assignee: JMAC Resources, Inc.

(21) Appl. No.: 15/474,029

(22) Filed: Mar. 30, 2017

(51) Int. Cl. B01D 47/06; B28C 5/42

(52) U.S. Cl. CPC B01D 47/06; B28C 5/4248

(57) ABSTRACT

A mixer truck water spray bar for suppression of dust clouds is disclosed. The mixer truck water spray bar generally includes an entrance chute configured to receive water from the drum via the mixer chute that is removably attachable to the mixer chute and a manifold attached to the entrance chute that is oriented substantially perpendicular to the entrance chute and is configured to receive water from the entrance chute via an entrance opening and comprises a plurality of apertures configured to externally distribute water received through the entrance opening through the apertures without the use of a pump.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a water spray bar that enables a mixer truck with a drum and mixer chute to distribute water from the drum in a manner that can suppress dust cloud formation.

### Related Art

Any discussion of the related art throughout the specification should in no way be considered as an admission that such related art is widely known or forms part of common general knowledge in the field.

Near concrete ready-mix plants and the gravel haul rods that lead to and from these plants, the creation of large dust clouds is a major problem. In order to combat this problem, there are several unsatisfactory options. One option is the use of chemical dust suppression agents, such as magnesium chloride. This method is costly and does not last very long under high traffic conditions. Another method is the use of water trucks with spray bars and gas-powered pumps. This method requires the maintenance of a separate piece of equipment that may only be used for one hour per day. Another method is to distribute water from the concrete mixer barrel and down its ordinary chute. Using an ordinary chute in this manner does not evenly distribute water, which results in either wasted water or less effective dust suppression. Thus, the existing methods of dust suppression are either inefficient or needlessly expensive.

### SUMMARY

An example embodiment is directed to a water spray bar for a mixer truck that can efficiently distribute water to suppress dust cloud formation using its drum and mixer chute. The water spray bar generally includes an entrance chute configured to receive water from a mixer truck's drum via the mixer truck's chute. The entrance chute is removably attachable to the mixer truck's chute using one or more connectors on the mixer truck's chute and one or more hooks on the entrance chute. A manifold is attached to the entrance chute that is oriented substantially perpendicular to the entrance chute and comprises a plurality of apertures configured to externally distribute water through the apertures without the use of the pump.

There has thus been outlined, rather broadly, some of the embodiments of the mixer truck water spray bar in order that the detailed description thereof may be better understood, and in order that the present contribution to the art may be better appreciated. There are additional embodiments of the mixer truck water spray bar that will be described hereinafter and that will form the subject matter of the claims appended hereto. In this respect, before explaining at least one embodiment of the mixer truck water spray bar in detail, it is to be understood that the mixer truck water spray bar is not limited in its application to the details of construction or to the arrangements of the components set forth in the following description or illustrated in the drawings. The mixer truck water spray bar is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a water spray bar attached to a mixer truck in accordance with an embodiment thereof.

FIG. 2 is a close-up perspective view of a water spray bar shown in FIG. 1.

FIG. 3 is a side-view of a water spray bar attached to a mixer truck.

FIG. 4a is a side view of a water spray bar about to be attached to a mixer chute of a mixer truck.

FIG. 4b is a side view of a water spray bar with its hooks engaged with the connectors on a mixer chute of a mixer truck.

FIG. 4c is a side view of a water spray bar that has been attached to the mixer chute of a mixer truck.

FIG. 5 is a cross-sectional view of a water spray bar attached to the mixer chute of a mixer truck.

FIG. 6 is a first top perspective view of a water spray bar.

FIG. 7 is a second top perspective view of a water spray bar.

FIG. 8 is a bottom perspective view of a water spray bar.

FIG. 9 is a side view of a water spray bar.

FIG. 10 is an opposing side view of a water spray bar.

FIG. 11 is a top-down view of a water spray bar.

FIG. 12 is a bottom-up view of a water spray bar.

FIG. 13 is an end view of a water spray bar.

FIG. 14 is an opposite end view of a water spray bar.

FIG. 15 is a third top perspective view of a water spray bar.

FIG. 16 is a side cross-section view of a water spray bar.

### DETAILED DESCRIPTION

### A. Overview

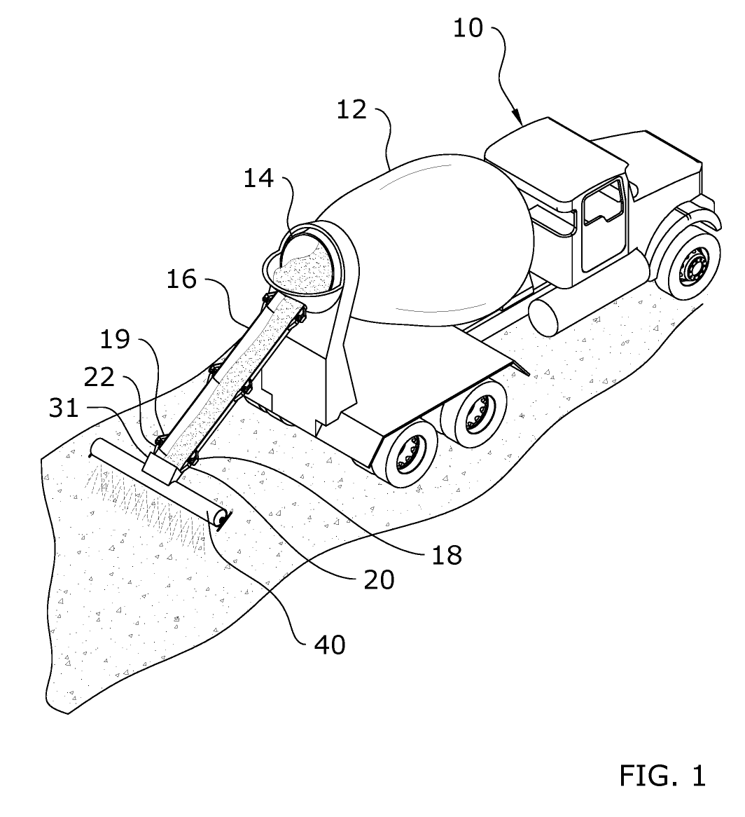

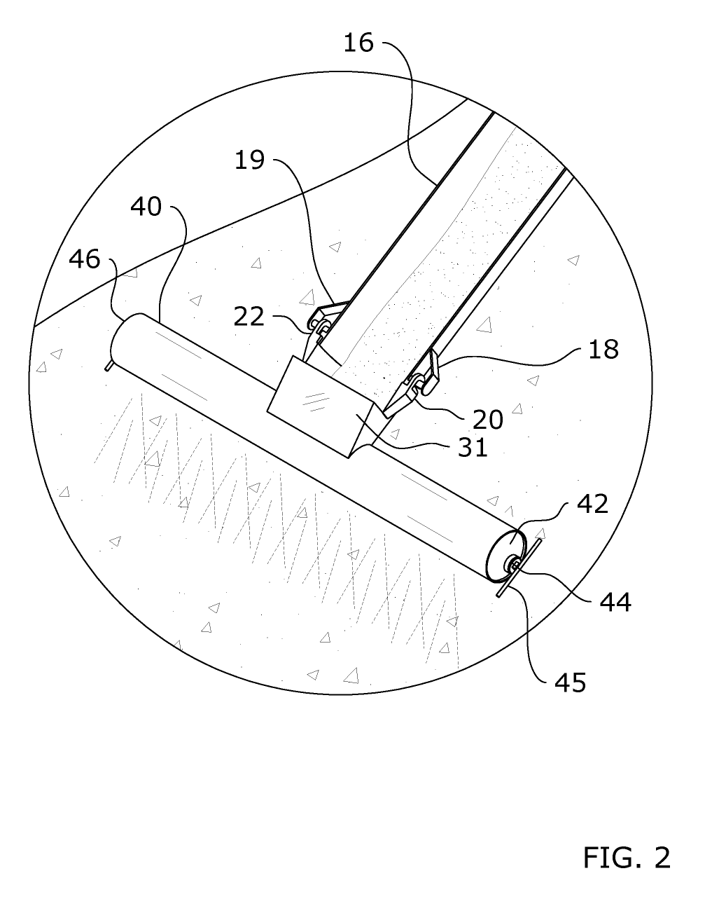

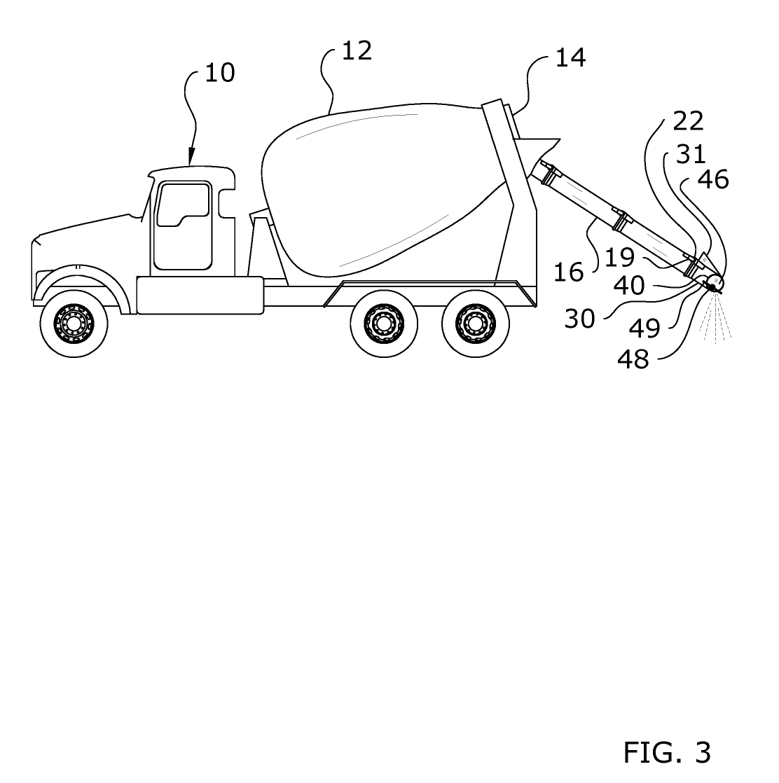

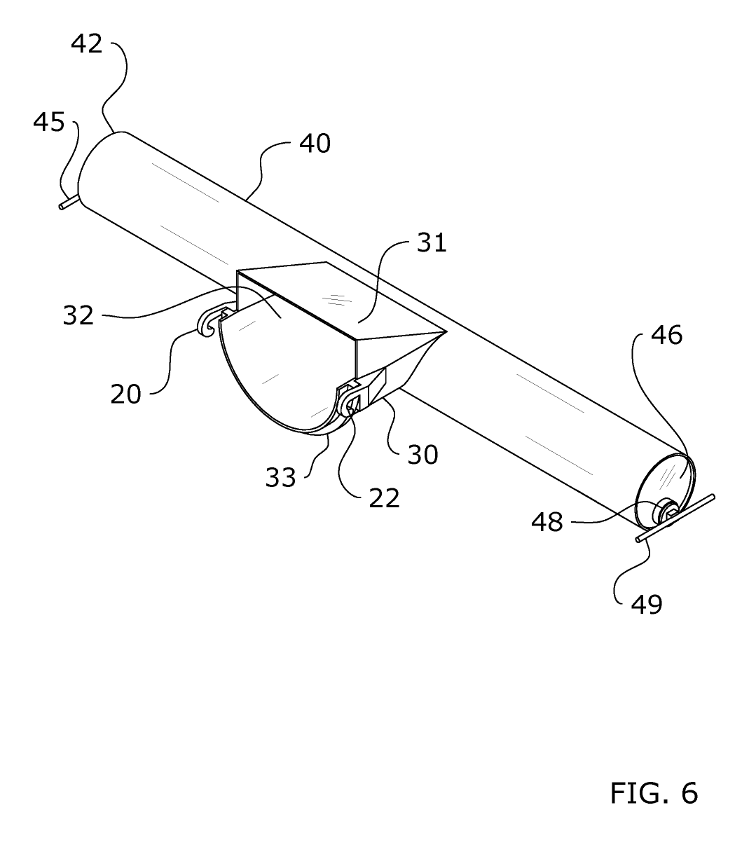

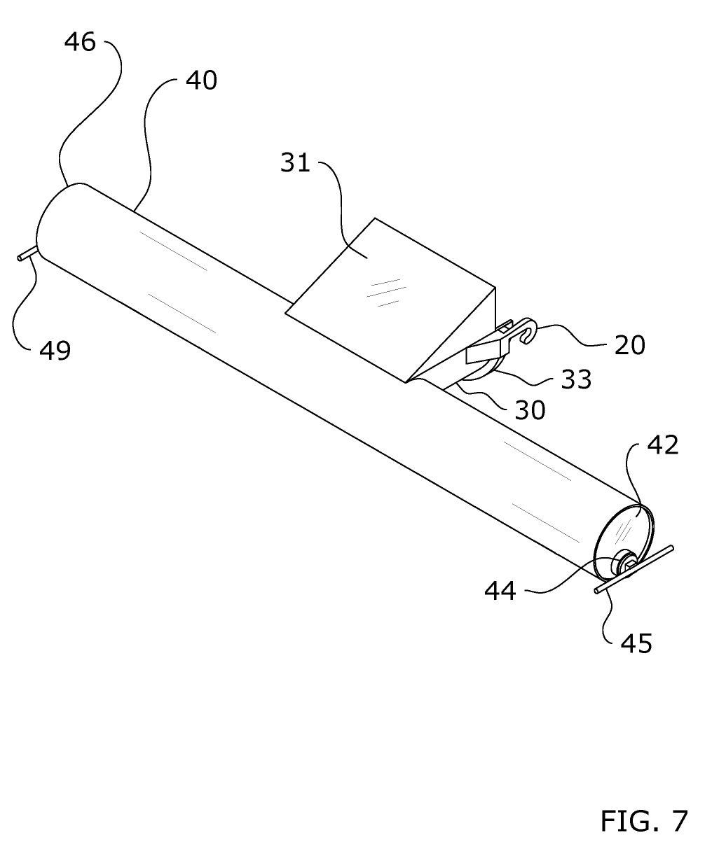

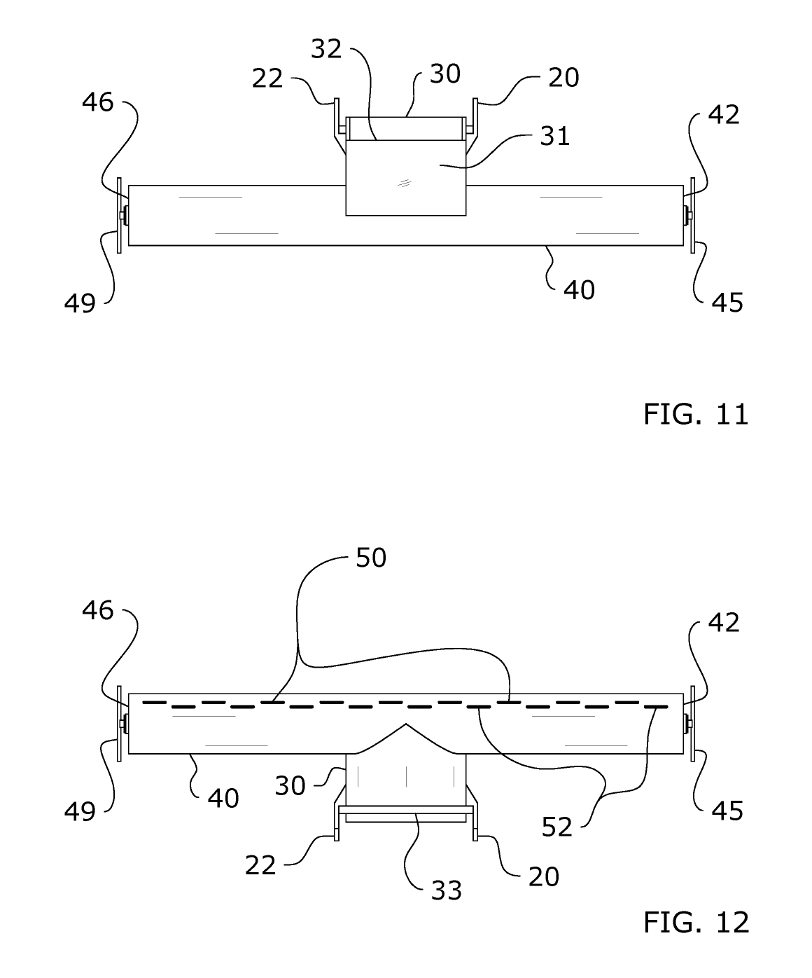

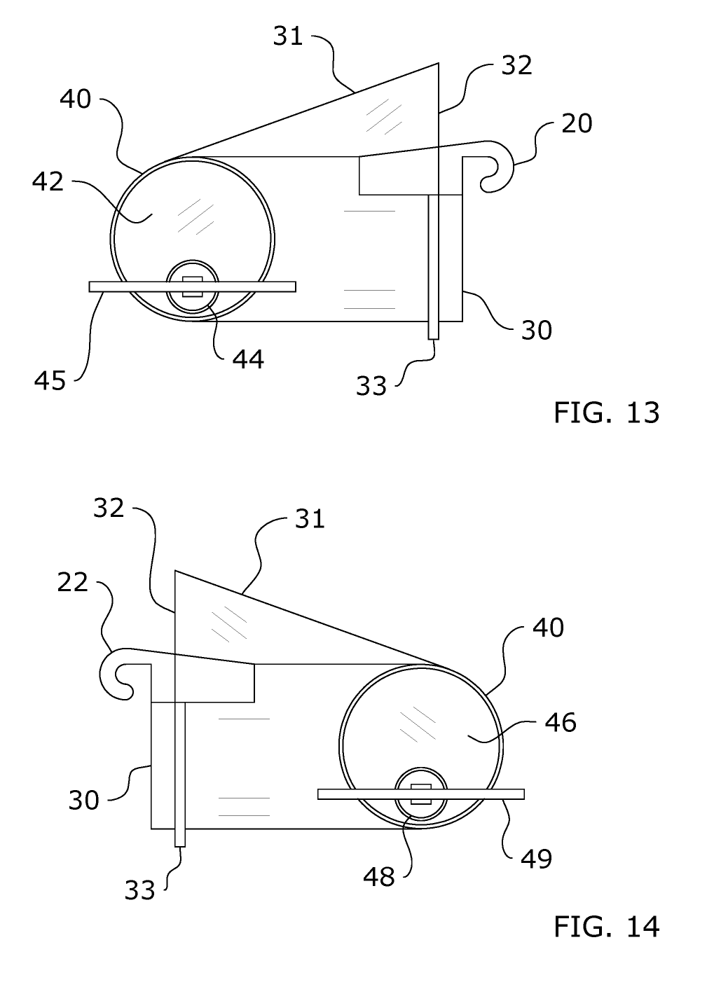

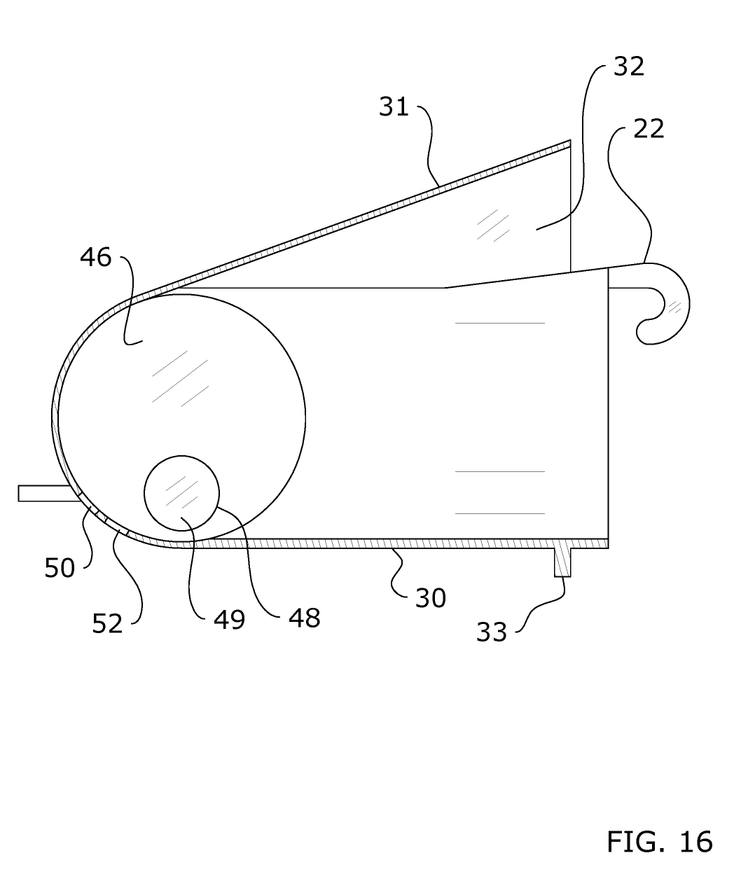

Turning now descriptively to the drawings, in which similar reference characters denote similar elements throughout the several views, FIGS. 1 through 16 illustrate a water spray bar for a mixer truck 10 having a drum 12 and a mixer chute 16, which comprises an entrance chute 30 configured to receive water from the drum 12 via the mixer chute 16, wherein the entrance chute 30 is removably attachable to the mixer chute 16 using a first connector 20 adapted for coupling with a first loop 18 on the mixer chute 16 and a second connector 22 adapted for coupling with a second loop 19 on the mixer chute 16; a manifold 40 attached to the entrance chute 30 that is oriented substantially perpendicular to the entrance chute 30 that is configured to receive water from the entrance chute 30 via an entrance opening 32 and comprises a plurality of apertures 50 configured to externally distribute water received from through the entrance opening 32 through the apertures 50 without the use of a pump or nozzles; wherein the first connector 20 is attached to the exterior of the entrance chute 30 and comprises a hook with an opening facing downward such that the first connector 20 can couple with the first loop 18 from above; wherein the second connector 22 is attached to the exterior of the entrance chute 30 and comprises a hook with an opening facing downward such that the second connector 22 can couple with the second loop 19 from above; wherein the entrance chute 30 is adapted to at least partially rest upon an underhang 17 of the mixer chute 16 when the entrance chute 30 is attached to the mixer chute 16; wherein the entrance chute 30 comprises a flange 33 adapted to contact an edge of the underhang 17; wherein the interior surface of the entrance chute 30 has substantially the same shape as the interior surface of the mixer chute 16 and is continuous with the interior surface of the mixer chute 16 at the point of attachment between the entrance chute 30 and the mixer chute 16; wherein at least one of the plurality of apertures 50 is a slot; wherein the manifold 40 comprises a reflective strip 60 attached to its exterior opposite the entrance chute 30; wherein the manifold 40 comprises at least one end 42 containing an opening 44 and a plug 45 removably attachable to the opening 44 to create a water-tight seal; wherein the manifold 40 has a cylindrical shape; and an entrance shroud 31 above the entrance chute 30, wherein the entrance shroud 31 substantially covers the entire exposed surface of the entrance chute 30.

The various embodiments of the present invention may be utilized with a typical ready-mix cement truck, such as, but not limited to a McNellius Mixer or a Schwing Mixer.

### B. Mixer Truck

The mixer truck 10 comprises a drum 12, a rear opening 14 and a mixer chute 16, and is best illustrated in FIGS. 1-3. The drum 12 contains water that is expelled from the drum 12 via rear opening 14 and down the mixer chute 16. This water then passes over entrance chute 30 and into manifold 40 of the water spray bar via entrance opening 32. The entrance chute 30 is removably attached to the mixer chute 16 using a first connector 20 and second connector 22 that couple to a first loop 18 and a second loop 19, respectively, on the mixer chute 16. The mixer chute 16 is preferably configured along a straight path, but could be configured in other ways. Similarly, mixer chute 16 could be comprised of a single segment as opposed to the multiple segments shown in FIGS. 1-3.

### C. Entrance Chute

The water spray bar has an entrance chute 30 that is attached to mixer chute 16 to receive water from the drum 12 of the mixer truck 10 as illustrated in FIGS. 1-16. Entrance chute 30 is adapted to be removably attachable to mixer chute 16 to create a path for water to flow from drum 12 into manifold 40. Mixer chute 16 comprises a first loop 18 and a second loop 19. Entrance chute 30 comprises a first connector 20 and a second connector 22 attached to the exterior of entrance chute 30, wherein both connectors 20, 22 are adapted to couple with first loop 18 and second loop 19, respectively. As shown in the figures, entrance chute 30 and mixer chute 16 preferably form a continuous path once the water spray bar has been attached.

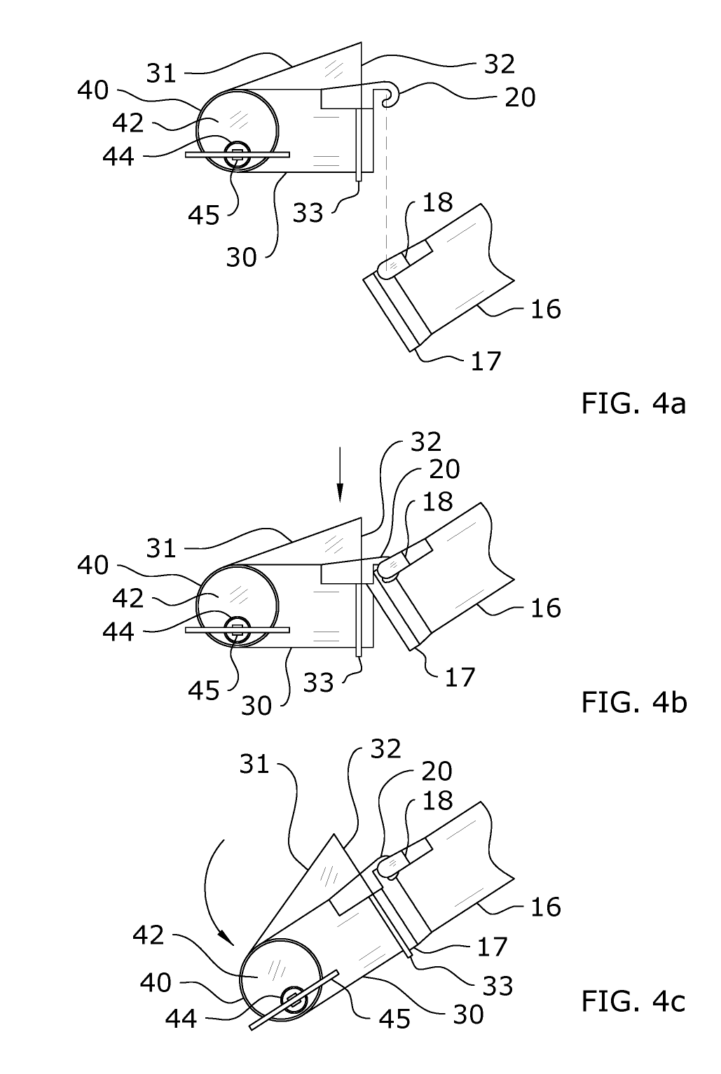

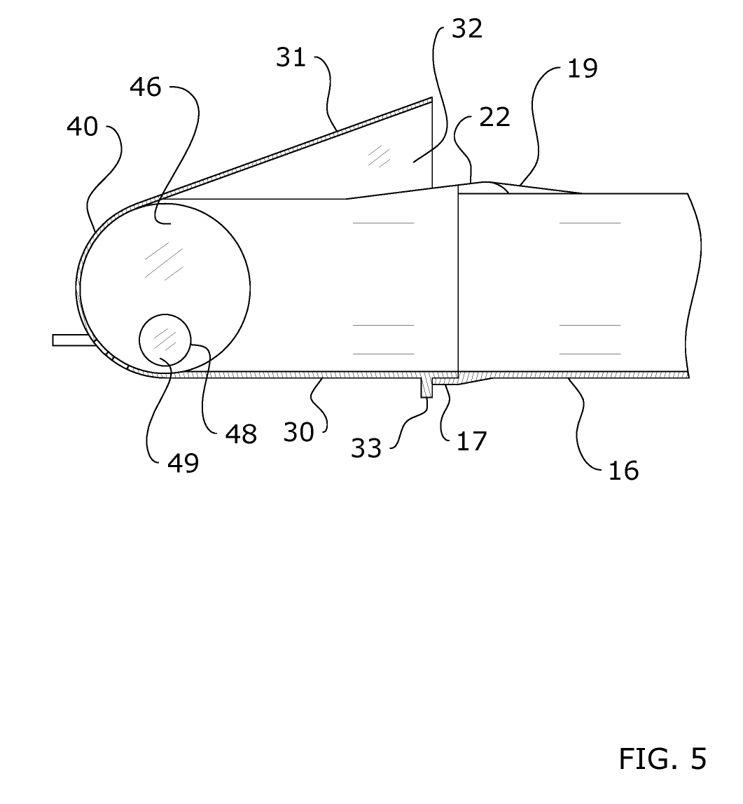

As shown in FIGS. 4a-c, and 5, first connector 20 and second connector 22 comprise hooks with openings facing downward. By approaching first loop 18 and second loop 19 at an angle from above, as illustrated in FIG. 4a, the hook openings on connectors 20, 22 can be engaged with their respective loops by placing their respective openings on their respective loops, as illustrated in FIG. 4b. After the first connector 20 and second connector 22 are engaged with first loop 18 and second loop 19, the entrance chute 30 can be pivoted downward by lowering it until flange 33 engages with the outer edge of underhang 17 of mixer chute 16, as shown in FIGS. 4c and 5. As shown in FIG. 5, once entrance chute 30 is attached to mixer chute 16, an outer edge portion of entrance chute 30 rests upon underhang 17. The weight and angle of entrance chute 30 combined with the coupling between connectors 20, 22 and loops 18, 19 keep entrance chute 30 attached to mixer chute 16.

In order to detach entrance chute 30 from mixer chute 16, the reverse process is utilized. Entrance chute 30 is pivoted upward by lifting it at least until flange 33 disengages with the outer edge of underhang 17. Entrance chute 30 is further lifted until it has been sufficiently pivoted at connectors 20, 22, such that they can be lifted off of loops 18, 19. Entrance chute 30 and mixer chute 16 can be reattached as needed.

Although first connector 20 and second connector 22 are illustrated as hooks with openings facing downward, these connectors 20, 22 could also have hooks with openings facing upward. In such an embodiment, the entrance chute 30 would need to approach mixer chute 16 from the side. Alternatively, if loops 18, 19 were configured to be within the interior of mixer chute 16, connectors 20, 22 could be similarly configured inside entrance chute 30. Moreover, first connector 20 and second connector 22 may not have the same configuration. For example, the first connector 20 could further comprise a locking mechanism the uses a lever or a spring-loaded catch to enhance the attachment of entrance chute 30 to mixer chute 16. In addition, flange 33 and underhang 17 could also comprise one or more connectors 20, 22 and loops to create additional removable attachment points.

Entrance chute 30 creates a path to entrance opening 32 of manifold 40. When attached to mixer chute 16, water from drum 12 can pass through rear opening 14, down mixer chute 16, over entrance chute 30, and through entrance opening 33 into manifold 40. Entrance chute 30 can also include an entrance shroud 31. Entrance shroud 31 can capture water from mixer chute 16 or entrance chute 30 that might otherwise slosh over the sides of entrance chute 30 or over the top of entrance opening 33. Entrance shroud 31 can also prevent the introduction of dust or other debris into manifold 40 via entrance opening 33. Although entrance shroud 31 is shown covering substantially all of the exposed surface of entrance chute 30, entrance shroud 31 could also cover part of mixer chute 16 or could cover less than substantially all of the exposed surface of entrance chute 30.

### D. Manifold

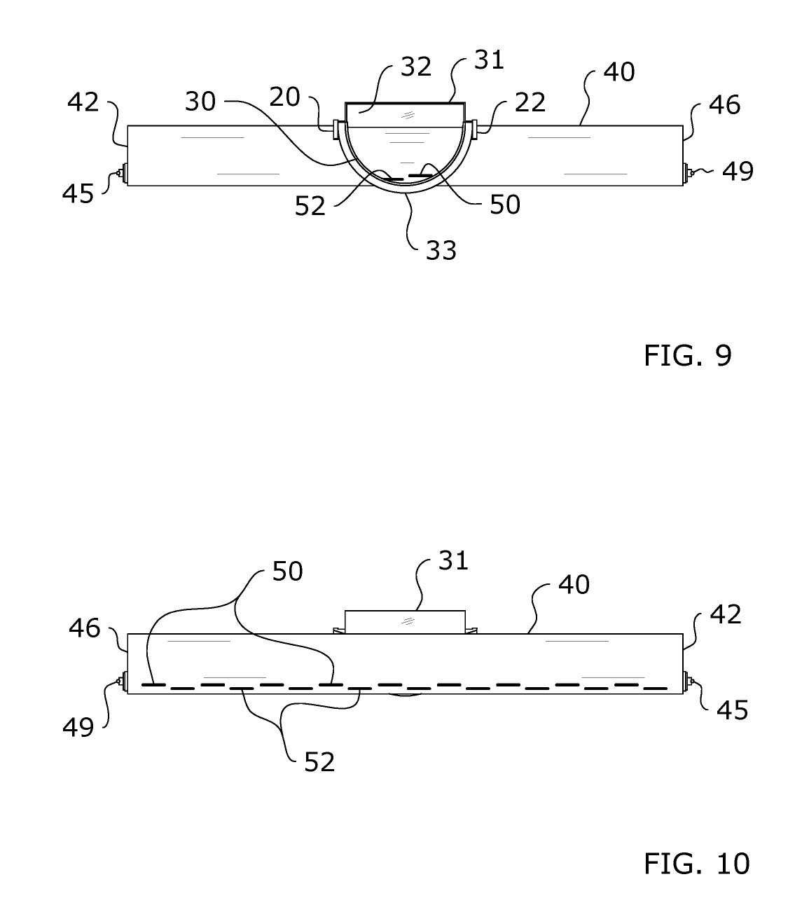

Entrance chute 30 is attached to a manifold 40, as best illustrated in FIGS. 1-16. Manifold 40 is attached to the entrance chute 30 in a manner that is oriented substantially perpendicular to entrance chute 30. Manifold 40 has a cylindrical shape and is configured to receive water that passes over entrance chute 30 and through entrance opening 32. The entrance opening 32, as shown in FIG. 9, has the same shape as entrance chute 30 and spans the entire diameter of manifold 40. However, entrance chute 30 could be smaller than what is illustrated.

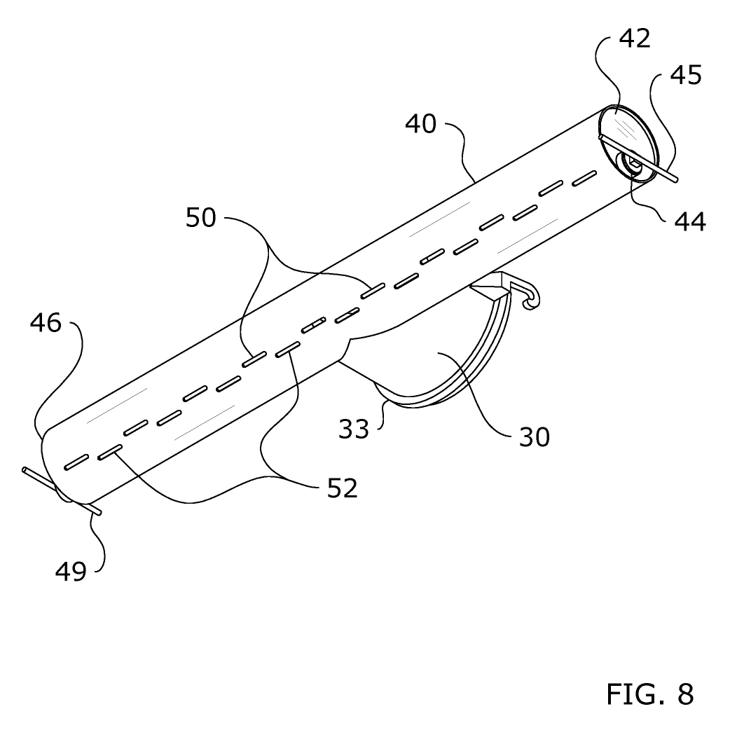

Manifold 40 comprises a plurality of apertures 50, 52 as illustrated in FIGS. 8, 10, and 12. The apertures 50, 52 shown in FIGS. 8, 10, and 12 are slots that oriented with the main axis (i.e., from first end 42 to second end 46). These apertures 50, 52 are evenly spaced and staggered about a line oriented with the main axis. This could also be described as slots 50 being evenly spaced along a first line oriented with the main axis of manifold 40 and slots 52 being evenly spaced along a second line oriented with the main axis of manifold 40, wherein the second line and first line are laterally proximate to each other with slots 50, 52 not being laterally adjacent. Either way, slots 50, 52 (or apertures 50, 52 more generally) are distributed in a such a manner that water received into manifold 40 via entrance opening 32 will be evenly distributed externally.

Manifold 40 contains a first end 42 and a second end 46 that contain a first opening 44 and second opening 48, respectively, as illustrated in FIGS. 1-16. Openings 44, 48 provide additional capability to clean, unclog, or otherwise service the inside of manifold 40. First opening 44 and second opening 48 have a corresponding first plug 45 and second plug 49. First opening 44 and second opening 48 are not required to have a circular shape or the same shape as each other. However, the shape of the first plug 45 is configured to match the shape of first opening 44, whatever that shape may be. Similarly, the shape of second plug 49 is configured to match the shape of second opening 48. Preferably, first plug 45 and second plug 49 will create a water-tight seal with their respective openings 44, 48.

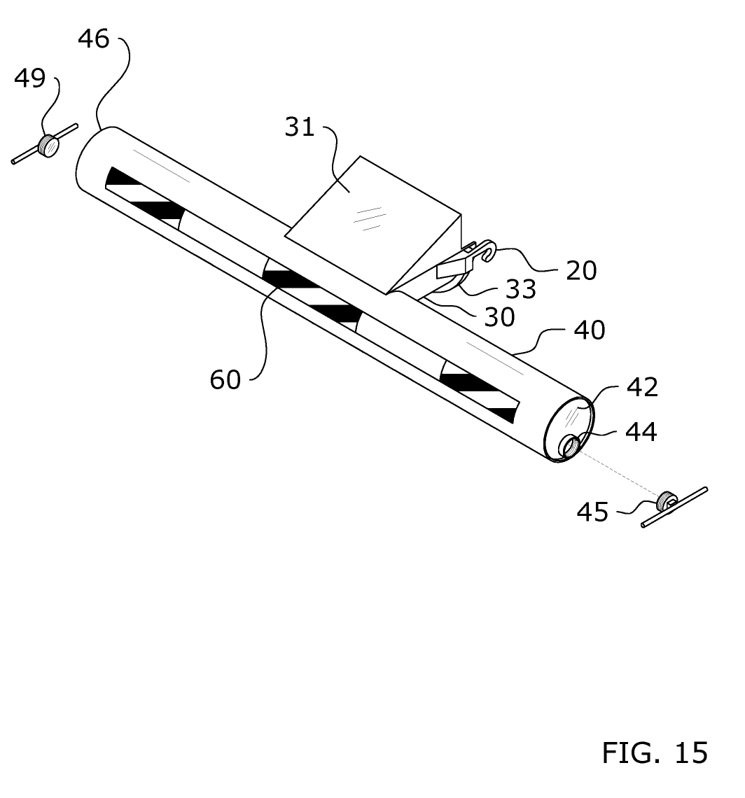

As shown in FIG. 15, manifold 40 may comprise a reflective strip 60 on the side opposite entrance chute 30. Once the disclosed water spray bar is attached to the mixer chute 16, it may obscure or block safety markings on the back of the mixer truck 10. The addition of reflective strip 60 makes the use of the disclosed water spray bar safer for the mixer truck 10 and any nearby vehicles. In other embodiments, the reflective strip 60 could be enhanced or replaced with a flashing light, or a brake light coupled to the brake pedal of the mixer truck 10.

### E. Operation of Preferred Embodiment

In use, the entrance chute 30 of the disclosed water spray bar is attached to the mixer chute 16 of a mixer truck 10. The entrance chute 30 is attached to the mixer chute 16 by coupling a first connector 20 on the entrance chute 30 to a first loop 18 on the mixer chute 16 and a second connector 22 on the entrance chute 30 to a second loop 19 on the mixer chute 16. The first connector 20 is coupled to the first loop 18 by lowering a hook opening on the first connector 20 upon the first loop 18. The second connector 22 is coupled to the second loop 19 by lowering a hook opening on the second connector 22 upon the second loop 19. Once both connectors 20, 22 are coupled to their respective loops 18, 19, the entrance chute 30 is pivoted downward by lowering it until flange 33 on entrance chute 30 engages with an underhang 17 on mixer chute 16.

Either before or after the water spray bar has been attached, the drum 12 of the mixer truck 10 is filled with a desired amount of water. Once the water spray bar has been attached and the mixer truck 10 has been filed with the desired amount of water, the mixer truck 10 is moved to the desired location for dust suppression, if not already located there. Then, the drum 12 is operated so as to cause water to pass through rear opening 14, down mixer chute 16, over entrance chute 30 and through entrance opening 32 into manifold 40. Some amount of water may contact the interior of entrance shroud 31 before passing through entrance opening 32. The water that passes into manifold 40 is distributed out of apertures 50, 52 onto the road surface or other area where dust suppression is desired. The mixer truck 10 with attached operating water spray bar drives over any surface where dust suppression is desired and the mixer truck 10 is permitted to travel. This process continues until the desired dust suppression effect has been achieved, the supply of water has been depleted, or the driver or mixer truck 10 is otherwise unavailable to continue performing dust suppression.

Once the water spray bar is no longer needed and assuming the mixer truck 10 is parked and the flow of water halted, the water spray bar can be removed in much the same way that it was attached. The entrance chute 30 is lifted upward and pivoted at first connector 20 and second connector 22 until flange 33 is no longer engaged with underhang 17. Entrance chute 30 will continue to be lifted and pivoted until it is possible to lift first connector 20 and second connector 22 off of first loop 18 and second loop 19. Once the first connector 20 and second connector 22 are no longer coupled, the water spray bar can be stored for future use by this mixer truck 10 or another mixer truck 10 as needed.

Unless otherwise defined, all technical and scientific terms used herein have the same meaning as commonly understood by one of ordinary skill in the art to which this invention belongs. Although methods and materials similar to or equivalent to those described herein can be used in the practice or testing of the water spray bar for a mixer truck, suitable methods and materials are described above. All publications, patent applications, patents, and other references mentioned herein are incorporated by reference in their entirety to the extent allowed by applicable law and regulations. The water spray bar for a mixer truck may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A water spray bar for a mixer truck having a drum and a mixer chute, comprising:
an entrance chute configured to receive water from the drum via the mixer chute;
wherein the entrance chute is removably attachable to the mixer chute using a first connector adapted for coupling with a first loop on the mixer chute and a second connector adapted for coupling with a second loop on the mixer chute; and
a manifold attached to the entrance chute that is oriented substantially perpendicular to the entrance chute, that is configured to receive water from the entrance chute via an entrance opening and comprises a plurality of apertures configured to externally distribute water received through the entrance opening through the apertures without the use of a pump.

2. The water spray bar of claim 1, wherein the first connector comprises a hook with the opening facing downward such that the first connector can couple with the first loop from above.

3. The water spray bar of claim 2, wherein the second connector comprises a hook with the opening facing downward such that the second connector can couple with the second loop from above.

4. The water spray bar of claim 1, wherein the first connector is attached to the exterior of the entrance chute.

5. The water spray bar of claim 1, wherein the second connector is attached to the interior of the entrance chute.

6. The water spray bar of claim 5, wherein the entrance chute is adapted to at least partially rest upon an underhang of the mixer chute when the entrance chute is attached to the mixer chute.

7. The water spray bar of claim 1, wherein the interior surface of the entrance chute has substantially the same shape as the interior surface of the mixer chute at the point of attachment between the entrance chute and the mixer chute.

8. The water spray bar of claim 7, wherein the entrance chute comprises a flange adapted to contact an edge of the underhang.

9. The water spray bar of claim 1, wherein the interior of the entrance chute continuous with the interior of the mixer chute.

10. The water spray bar of claim 1, wherein at least one of the plurality of apertures is a slot.

11. The water spray bar of claim 1, wherein at least one of the plurality of apertures is a hole.

12. The water spray bar of claim 1, further comprising a shroud above the entrance chute.

13. The water spray bar of claim 12, wherein the shroud substantially covers the entire exposed surface of the entrance chute.

14. The water spray bar of claim 1, wherein the manifold comprises a reflective strip attached to its exterior opposite the entrance chute.

15. The water spray bar of claim 1, wherein the manifold further comprises at least one end containing an opening and a plug removably attachable to the opening.

16. The water spray bar of claim 1, wherein the plug is adapted to create a water-tight seal when removably attached.

17. The water spray bar of claim 1, wherein the manifold has a cylindrical shape.

18. The water spray bar of claim 1, wherein the plurality of apertures are arranged along a radial axis of the manifold.

19. The water spray bar of claim 1, wherein the manifold is further configured to externally distribute water received from the entrance chute through the apertures without the use of nozzles.

20. A water spray bar for a mixer truck having a drum and a mixer chute, comprising:
an entrance chute configured to receive water from the drum via the mixer chute:
wherein the entrance chute is removably attachable to the mixer chute using a first connector adapted for coupling with a first loop on the mixer chute and a second connector adapted for coupling with a second loop on the mixer chute;
a manifold attached to the entrance chute that is oriented substantially perpendicular to the entrance chute, that is configured to receive water from the entrance chute via an entrance opening and comprises a plurality of apertures configured to externally distribute water received through the entrance opening through the apertures without the use of a pump or nozzles;
wherein the first connector is attached to the exterior of the entrance chute and comprises a hook with an opening facing downward such that the first connector can couple with the first loop from above;
wherein the second connector is attached to the exterior of the entrance chute and comprises a hook with an opening facing downward such that the second connector can couple with the second loop from above;
wherein the entrance chute is adapted to at least partially rest upon an underhang of the mixer chute when the entrance chute is attached to the mixer chute;
wherein the entrance chute comprises a flange adapted to contact an edge of the underhang;
wherein the interior surface of the entrance chute has substantially the same shape as the interior surface of the mixer chute and is continuous with the interior surface of the mixer chute at the point of attachment between the entrance chute and the mixer chute;
wherein at least one of the plurality of apertures is a slot;
wherein the manifold comprises a reflective strip attached to its exterior opposite the entrance chute;
wherein the manifold comprises at least one end containing an opening and a plug removably attachable to the opening to create a water-tight seal;
wherein the manifold has a cylindrical shape; and
a shroud above the entrance chute, wherein the shroud substantially covers the entire exposed surface of the entrance chute.
